(19) United States
(12) Patent Application Publication
(10) Pub. No.: US 2008/0018657 A1
(43) Pub. Date: Jan. 24, 2008

(54) System and Method for Managing an Information Handling System Display Presentation

(76) Inventor: Bruce Montag, Austin, TX (US)

Correspondence Address: HAMILTON & TERRILE, LLP, P.O. BOX 203518, AUSTIN, TX, 78720, US

(21) Appl. No.: 11/458,138

(22) Filed: Jul. 18, 2006

(51) Int. Cl. G09G 5/00

(52) U.S. Cl. 345/581

(57) ABSTRACT

An information handling system display accepts manual user inputs of display presentation parameters at a local display input device and communicates the inputs to an information handling system for application of the input presentation parameters to visual information provided from the information handling system to the display. The information handling system generates a display icon for presentation at the display that is representative of the user inputs at the display, such as a brightness, contrast or color gain setting. For example, a DisplayPort compliant auxiliary link communicates user inputs from a timing controller of the sink device of the display to a display input manager of the source device of the information handling system. Visual information adjusted for the user input presentation parameter is communicated from the source device through the main link to the sink device for presentation at the display.

### BACKGROUND OF THE INVENTION

1. Field of the Invention

The present invention relates in general to the field of information handling system displays, and more particularly to a system and method for managing an information handling system display presentation.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often present information at an external display, such as a liquid crystal display (LCD), a cathode ray tube (CRT) display or a plasma display. Typically, information handling systems communicate visual information to the display through a standardized cable, such as a VGA cable or a DVI cable. The visual information allows for presentation of a visual image at the display. Displays typically include a display controller on a printed circuit board with a variety of electronic components to receive the display signal, scale the image to the native resolution of the display, process the image for contrast and gamma correction, render an on screen display (OSD) and translate the display signal to LVDS for presentation on a display panel. Although the visual image is generated at an information handling system, the overall quality of the image is usually established by user inputs of presentation parameters to the display itself For instance, a display typically allows brightness, contrast, color gain and other manual alterations to overall display quality through buttons located on the display. End user manipulation of the buttons generally initiates a user interface presented at the display by the display controller. The end user selects desired display quality presentation parameter settings, such as brightness, by inputting the desired settings through the buttons and confirming the setting with the user interface presented by the display controller.

In order to reduce the expense and complexity of information handling system displays, the DisplayPort standard was recently introduced to define a new category of display known as a “direct drive” display. A direct drive display does not need a display controller board since its host information handling system graphics system performs image processing and on screen display rendering. A DisplayPort cable communicates visual information from an information handling system for presentation at the display through a unidirectional main link. Visual information is sent as pixel values that are managed at the display with a timing controller. Control information is communicated between the display and the information handling system through a bidirectional auxiliary link with Monitor Control Command Set (MCCS) commands. Instead of having buttons on the display to manage overall display quality settings, such as brightness and contrast, direct drive displays have software graphic user interface (GUI) controls that run on the host information handling system. For example, an application running on the information handling system generates visual information for presentation at the display which allows the end user to select brightness and contrast settings. The user settings are input at the information handling system and sent to the graphics system. The graphics system then processes visual information to apply the display quality settings. One difficulty with this approach is that end users face a new usage model, the inputting of display quality settings through an information handling system instead of display buttons, which may create some user discomfort.

### SUMMARY OF THE INVENTION

Therefore a need has arisen for a system and method which supports display quality inputs at a direct drive display device.

In accordance with the present invention, a system and method are provided which substantially reduce the disadvantages and problems associated with previous methods and systems for accepting inputs at a display device. Display presentation parameter inputs at local display input devices are communicated to an information handling system. The information handling system applies the input presentation parameters to process and render visual information according to the presentation parameters and also provides a visual representation of the presentation parameters for presentation at the display.

More specifically, visual information generated by information handling system processing components is communicated from a source device through a cable to a display sink device for presentation at the display, such as with a DisplayPort cable. The display accepts display presentation parameters input through buttons located on the display by converting manual inputs into electrical signals, such as step signals generated by the display timing controller. The electrical signals are packetized and communicated to the information handling system, such as through an auxiliary link with MCCS command headers. A display input manager on the information handling system analyzes and applies the display presentation parameters to visual information generated at the information handling system, such as by adjusting the brightness, contrast and color gain of the visual information. The visual information is communicated to the display for presentation according to the inputs made at the display. In addition, a visual representation of the display inputs is generated at the information handling system for presentation at the display to provide user feedback of the selected display presentation parameters, such as with an icon representing the selected brightness, contrast and color gain settings.

The present invention provides a number of important technical advantages. One example of an important technical advantage is that a conventional usage model remains available with a direct drive display. End user inputs to buttons on a display are communicated from the display to an information handling system for processing according to the direct drive usage model. A user interface generated at the information handling system and presented at the display provides the end user with the impression that the display is directly managed by the button inputs even though the display lacks the physical processing capability for such direct management. This allows less expensive displays built to the DisplayPort standard to operate with a conventional usage model that otherwise needs greater local processing capability.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system configured to accept and apply presentation parameters input at a display; and

FIG. 2 depicts a flow diagram of a process for accepting presentation parameters from a display and applying the presentation parameters at an information handling system for visual information communicated to the display.

### DETAILED DESCRIPTION

Displays that have presentation parameters managed at an information handling system, such as DisplayPort compliant displays, support local user inputs to adjust display parameters by communicating the local user inputs to the information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

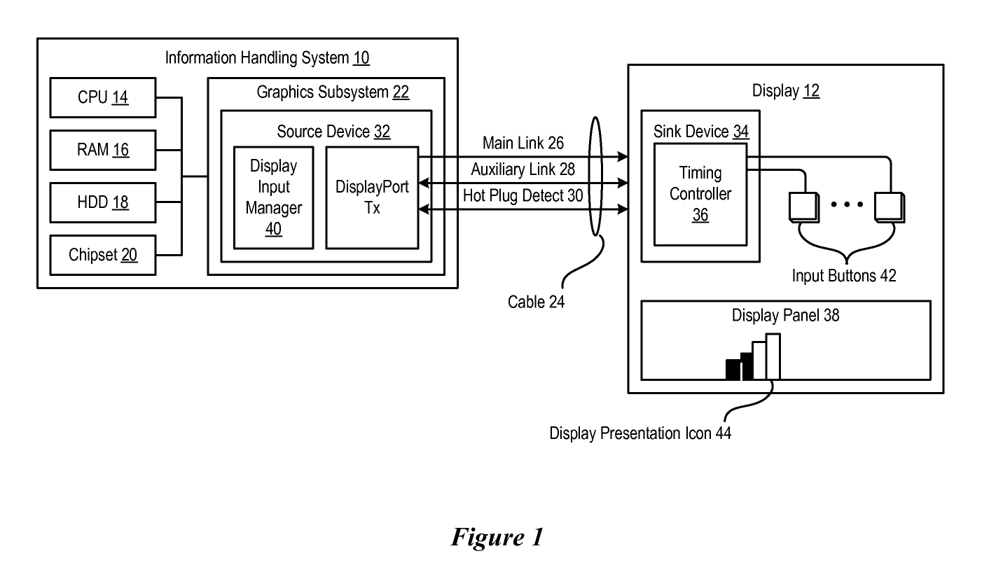

Referring now to FIG. 1, a block diagram depicts an information handling system 10 configured to accept and apply presentation parameters input at a display 12, such as adjustments to brightness, contrast or color gain. Information handling system 10 has plural processing components for processing information, such as a central processing unit (CPU) 14, RAM 16, a hard disk drive (HDD) 18, a chipset 20 and a graphics subsystem 22. For example, an application running on CPU 14 generates visual information for presentation to an end user at display 12. The visual information is communicated through a cable 24, such as a DisplayPort cable having a unidirectional main link 26, a bidirectional auxiliary link 28 and a hot plug detect link 30. A source device 32 in graphics subsystem 22 receives visual information from the processing components, formats the visual information for presentation at display 12 and communicates the formatted visual information through main link 26. A sink device 34 in display 12 receives the visual information and, with a timing controller 36, communicates the visual information to pixels of display 12 for presentation of a visual image at a display panel 38. Source device 32 and sink device 34 communicate control information between each other through auxiliary link 28 using a micropacket architecture and MCCS commands defined by the DisplayPort standard.

During operations defined by the DisplayPort standard, end user adjustments to display presentation parameters are managed through graphics subsystem 22 with inputs made at information handling system 10. For instance, if the end user desires greater display brightness, a graphical user interface is made available by graphics subsystem 22 and alterations to display brightness are applied at source device 32 to the visual information sent to sink device 34. Moving presentation parameter management from the display to the information handling system allows for manufacture of less expensive and complex displays, however, changes the usage model to one that is unfamiliar to information handling system users. In order to continue to support display presentation parameter management through user inputs at the display without incorporating greater intelligence at the display, a display input manager 40 associated with source device 32 monitors auxiliary link 28 for alterations to display presentation parameters input at display 12. Display input buttons 42 located at display 12 accept manual user inputs to manage display presentation parameters. Display input buttons 42 are electrically connected to pins of timing controller 36, which converts electrical signals generated by manipulation of input buttons 42 into step signals representative of a user input to alter a display presentation parameter. The step signal is packed into a DisplayPort micropacket with an appropriate MCCS command header and transmitted to source device 32 over auxiliary link 28. Thus, although display management functions are performed at information handling system 10 and not by display 12, inputs are managed through display 12.

Display input manager 40 detects display presentation parameter inputs sent through auxiliary link 28 and applies the inputs to alter the visual information sent from source device 32. For instance, brightness, contrast and color gain inputs through input buttons 42 are applied to alter the brightness, contrast and color gain of visual information at source device 32 so that the visual image presented at display panel 38 has the desired presentation parameters. In addition, display input manager 40 generates a display presentation icon 44 sent through main link 26 for presentation at display panel 38. Display presentation icon 44 is representative of the display presentation parameters input through input buttons 42, such as the level of brightness, contrast or color gain set by an end user through display 12. For example, icon 44 presents a histogram near the location of the input button 42 manipulated by the end user to show the current setting and provide feedback for the end user when the button is pushed. Display input manager 40 operates as software, firmware or hardware that migrates management of display-level inputs to information handling system 10 so that display 12 needs less intelligence but still provides user-desired functionality.

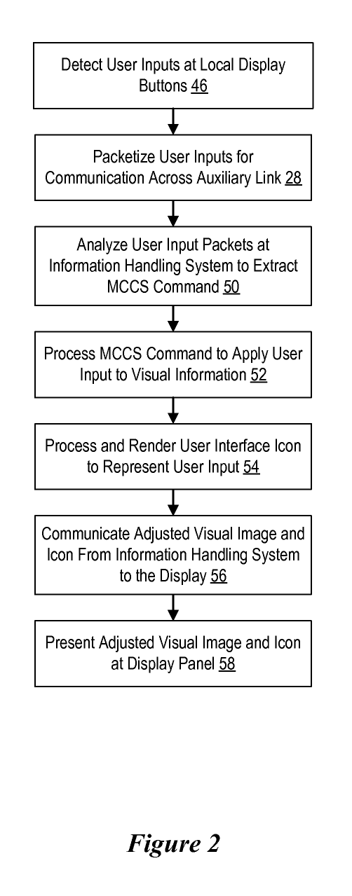

Referring now to FIG. 2, a flow diagram depicts a process for accepting presentation parameters from a display and applying the presentation parameters at an information handling system for visual information communicated to the display. The process begins at step 46 with detection of user inputs at local display buttons. At step 48, the local display inputs are packetized for communication to an information handling system, such as with MCCS command headers sent across a DisplayPort auxiliary link. At step 50, the user input packets are analyzed at the information handling system to extract MCCS commands that defined display presentation parameters input by the end user at the display. At step 52, the display presentation parameter MCCS commands are applied to visual information, such as by altering the brightness, contrast or color gain of the visual information. At step 54, a display presentation parameter icon is processed and rendered to provide visual information representative of the user input. At step 56, the visual image adjusted to the user input display presentation parameters and the icon representative of the presentation parameter are sent from the information handling system to the display. At step 58, the adjusted visual image and icon are presented at the display.

Although the present invention has been described in detail, it should be understood that various changes, substitutions and alterations can be made hereto without departing from the spirit and scope of the invention as defined by the appended claims.

What is claimed is:

1. An information handling system comprising:
a central processing unit operable to generate visual information;
a graphics subsystem interfaced with the central processing unit and operable to communicate the visual information through a cable to a display for presentation at the display; and
a display input manager associated with the graphics subsystem, the display input manager operable to detect user inputs made at the display and to apply the user inputs to alter the visual information presented at the display.

2. The information handling system of claim 1 wherein the user inputs comprise a display brightness setting.

3. The information handling system of claim 1 wherein the user inputs comprise a display contrast setting.

4. The information handling system of claim 1 wherein the user inputs comprise a display color gain setting.

5. The information handling system of claim 1 further comprising:
a display having one or more input devices interfaced with a sink device; and
a cable interfacing the sink device with the information handling system graphics subsystem, the cable having a main link operable to communicate visual information from the graphics subsystem to the sink device and an auxiliary link operable to communicate control information between the graphics subsystem and the sink device;
wherein the one or more display input devices accept the user inputs at the display and communicate the user inputs to the sink device; and
wherein the sink device communicates the user inputs to the graphics subsystem through the auxiliary link.

6. The information handling system of claim 5 wherein the sink device comprises a timing controller, the timing controller converting the user inputs at the display input devices into step signals.

7. The information handling system of claim 5 wherein the sink device communicates the user inputs through the auxiliary link as MCCS commands.

8. The information handling system of claim 1 wherein the display input manager is further operable to generate visual information based upon the user inputs and communicate the visual information to the display for presentation.

9. The information handling system of claim 8 wherein the user input comprises a brightness adjustment and the visual information generated by the display input manager comprises a display brightness icon.

10. A method for managing user inputs to an information handling system display, the method comprising:
detecting a user input to a local display input device;
communicating the user input from the display to the information handling system;
applying the user input to adjust visual information presentation parameters;
communicating visual information having the adjusted presentation parameters from the information handling system to the display; and
presenting the visual information at the display with the adjusted presentation parameters.

11. The method of claim 10 further comprising:
generating at the information handling system user input visual information that represents the user input;
communicating the user input visual information to the display; and
presenting the user input visual information at the display.

12. The method of claim 11 wherein the user input comprises a display brightness setting and the user input visual information comprises a display brightness icon.

13. The method of claim 10 wherein the user input comprises a display contrast setting.

14. The method of claim 10 wherein the user input comprises a display color gain setting.

15. The method of claim 10 wherein detecting a user input further comprises:
sending an electrical signal from the input device to a timing controller of the display; and
converting the electrical signal into a step signal.

16. The method of claim 15 wherein communicating the user input from the display to the information handling system further comprises:
sending the step signal as a MCCS command from the display through an auxiliary link to the information handling system.

17. A system for managing display presentation parameters with an information handling system, the system comprising:
a sink device associated with the display and operable to accept user inputs to input devices located at the display, the user inputs for altering the display presentation parameters; and
a source device associated with the information handling system and operable to receive the user inputs from the display for application by the information handling system to alter the display presentation parameters, the source device further operable to communicate visual information to the display with the altered display presentation parameters.

18. The system of claim 17 wherein the source device is further operable to generate a display icon representative of the altered display presentation and to communicate the display icon to the display for presentation.

19. The system of claim 18 wherein the display presentation parameter comprises display brightness.

20. The system of claim 18 wherein the display presentation parameter comprises display contrast.
